(19) United States
(12) Patent Application Publication
(10) Pub. No.: US 2019/0058504 A1
(43) Pub. Date: Feb. 21, 2019

(54) DATA TRANSFER SYSTEM, CONTROL UNIT, AND METHOD FOR TRANSFERRING DATA

(71) Applicant: VOLKSWAGEN AKTIENGESELLSCHAFT, Wolfsburg (DE)

(72) Inventors: Lorena DIAZ ORTEGA, Wolfsburg (DE); Friedel GERFERS, Berlin (DE)

(21) Appl. No.: 16/078,660

(22) PCT Filed: Jan. 24, 2017
(86) PCT No.: PCT/EP2017/051440

§ 371 Date: Aug. 22, 2018

(30) Foreign Application Priority Data
Feb. 26, 2016 (DE) 10 2016 203 078.7
Jul. 8, 2016 (DE) 10 2016 212 500.1
Jul. 15, 2016 (DE) 10 2016 212 991.0

(51) Int. Cl. H04B 3/487; H04B 3/32

(52) U.S. Cl. CPC H04B 3/487; H04B 3/32

(57) ABSTRACT

A data transfer system having a first control unit and a second control unit, wherein the transfer path between the two control signals is formed at least partially by a two-wire cable, by which a useful signal is transferred as a difference signal between the first control unit and the second control unit, wherein the first control unit has a transceiver and the second control unit has a receiver, wherein a measurement circuit to measure a common-mode component in the useful signal is arranged before the receiver of the second control unit, wherein an error correction circuit is provided, which produces a correction signal in accordance with the measured common-mode component, wherein a compensation circuit is arranged after the receiver, wherein the compensation circuit is designed so the useful signal received by the receiver is corrected by the correction signal.

### PRIORITY CLAIM

This patent application is a U.S. National Phase of International Patent Application No. PCT/EP2017/051440, filed 24 Jan. 2017, which claims priority to German Patent Application Nos. 10 2016 203 078.7, filed 26 Feb. 2016; 10 2016 212 500.1, filed 8 Jul. 2016; and 10 2016 212 991.0, filed 15 Jul. 2016, the disclosures of which are incorporated herein by reference in their entireties.

### SUMMARY

Illustrative embodiments relate to a data transfer system, a control unit and a method for data transfer.

### BRIEF DESCRIPTION OF THE DRAWINGS

The disclosed embodiments are explained below in more detail with reference to the drawings, in which:

FIG. 1 shows a schematic block diagram of a data transfer system in a first disclosed embodiment;

FIG. 2 shows a partial block diagram of a control unit;

FIG. 3 shows a schematic block diagram of a data transfer system in a second disclosed embodiment;

FIG. 4 shows a partial block diagram of a control unit; and

FIG. 5 shows a schematic block diagram of a data transfer system according to the prior art.

### DETAILED DESCRIPTION

Technological development in the transportation vehicle field is advancing rapidly, as a result of which the number of electrical and electronic systems in transportation vehicles is rising radically: Control Area Networks (CAN) systems, safety systems, communication, mobile media, infotainment systems including wireless headphones, DC motors and controllers, to mention but a few. The extreme restrictions on size and weight in transportation vehicle design demand that these systems have a very small (physical) form factor. This does not, however, necessarily mean that the electromagnetic emissions (EME) are also lower. If we now put a large number of electrical and electronic systems in the very restricted space (of a transportation vehicle), the problem of electromagnetic interference (EMI) as a result of mutual interference from cable and radiation emissions rises. The phenomenon of electromagnetic interference is also referred to as crosstalk. If this is not appropriately considered in the context of system design, mutual interference, even up to the level of system failures, can result. Due to the electrification of the transportation vehicle, the necessity of limiting EMI is more important than ever.

The networking of the individual assemblies in the transportation vehicle or commercial transportation vehicle will in future be based on electrical transceivers of the (automotive) IEEE standard 1000Base-T1. This standard uses a single unshielded twisted pair (UTP) cable for each channel to transmit data at up to 1 Gbit/s. Other UTP cables amongst other things couple into the transfer channel through electromagnetic interference, and influence/corrupt both the common-mode component as well as the differential mode of the transferred data signals. Very complex input filters are accordingly used, for example, for common-mode suppression (including common-mode chokes and so forth).

The problem described above is hardly any problem at all for the preceding standard 100Base-T1 (OABR) due to the very low signal bandwidth of 66 MHz. For the new standard 1000Base-T1, with a bandwidth of approximately 350-500 MHz, this is a significant problem, meaning that EMI reduces the signal-to-noise ratio (SNR) of the receiver, and consequently raises the bit error rate.

The disclosed embodiments are based on the technical problem of creating a data transfer system that comprehensively overcomes the problem of electromagnetic interference. A further technical problem is the creation of a suitable control unit and the provision of a suitable method for data transfer.

The solution to the technical problem emerges from a data transfer system, a control unit, and a method.

The data transfer system comprises for this purpose a first control unit and a second control unit, wherein the transfer path between the two control units is formed at least partially by a two-wire cable. A useful signal is transferred through the two-wire cable between the first control unit and the second control unit as a differential signal, wherein the first control unit comprises a transceiver and the second control unit comprises a receiver. A measuring circuit is arranged in front of the receiver of the second control unit, the measuring circuit being designed in such a way as to acquire a common-mode component in the useful signal. An error correction circuit is furthermore provided which is designed in such a way that, depending on the acquired common-mode component, a correction signal is generated. A compensation circuit is furthermore arranged behind the receiver, which is designed in such a way that the useful signal received through the receiver is corrected by the correction signal. An attempt to suppress the common-mode component before the receiver is thus not primarily made. Rather the negative effect from the common-mode component is determined and corrected behind the receiver. This permits a significantly more comprehensive compensation of interfering influences, as will be explained further later. The transfer of data between the first control unit and the second control unit may be bidirectional, so that the explanations for the first control unit also apply to the second control unit, and vice versa. The data transfer system may be an Ethernet transfer system. The two-wire cable may be an unshielded twisted pair UTP. Optionally the error correction circuit and the compensation circuit are integrated into a common chip of the receiver. This reduces the component variance, and allows a very compact construction with few components. The measuring circuit can also be integrated into the chip of the receiver.

Large interfering signals are generated in the transportation vehicle sector through switching processes in engines. The voltages induced on the two-wire cable here can be very high and lead to problems on the chip. In at least one disclosed embodiment a common-mode filter is therefore arranged in front of the receiver. The common-mode filter can here be a discrete or integrated passive network, or may be implemented as a common-mode choke.

In a further disclosed embodiment, the common-mode filter is integrated into the chip of the receiver, for example, as an LC network or, however, as an active component, for example, as a differential amplifier with high common-mode suppression. This permits a compact construction and a low number of components.

In a further disclosed embodiment, the measuring circuit is arranged in front of or in the common-mode filter. The benefit over a construction behind the common-mode filter, which is possible in principle, is that the common-mode signal to be acquired is larger and easier to acquire.

In a further disclosed embodiment, the error correction circuit and/or the compensation circuit are designed in such a way that a differential signal error in the useful signal resulting from a common-mode component to compensate. Such errors arise as a result of asymmetries in the transfer channel, for example, due to the two wires in the two-wire cable not having exactly the same length. Such errors cannot be corrected by a pure common-mode suppression as is known from the prior art. This can, however, be done since the common-mode component is acquired through measurement.

It should be noted here that this differential signal error is frequency-dependent as a result of common-mode components. Optionally, therefore, the transfer path is surveyed and a transfer function determined. This then indicates what sort of differential signal error is caused by a common-mode component depending on frequency.

In principle it is thus possible to determine this transfer function in advance, and to determine and correct these differential signal errors on the basis of the acquired common-mode components. In a further disclosed embodiment, the differential signal error is specified depending on at least one parameter. The temperature is, for example, such a parameter. Transfer functions can thus, for example, be stored for different temperatures, or, however, the parameter is used as a correction factor in the determination of the differential signal error.

Alternatively or in addition it can be provided that this transfer function is ascertained or checked during operation. For this purpose the first control unit is designed in such a way that in a calibration mode at least one common-mode signal is transferred to the other control unit, wherein a differential signal generated on the basis of the common-mode signal is acquired and used for adjusting the error correction circuit and/or the compensation circuit. It is to be borne in mind here that as a rule the location where the common-mode is coupled in when operating is not the first control unit, but is somewhere on the two-wire cable. This is, however, negligible, or, if appropriate, can be compensated for through correction terms.

Reference may be made to the full content of the foregoing explanations with respect to both the design of the control unit and the method.

A field of application is in an Ethernet transfer system in a transportation vehicle.

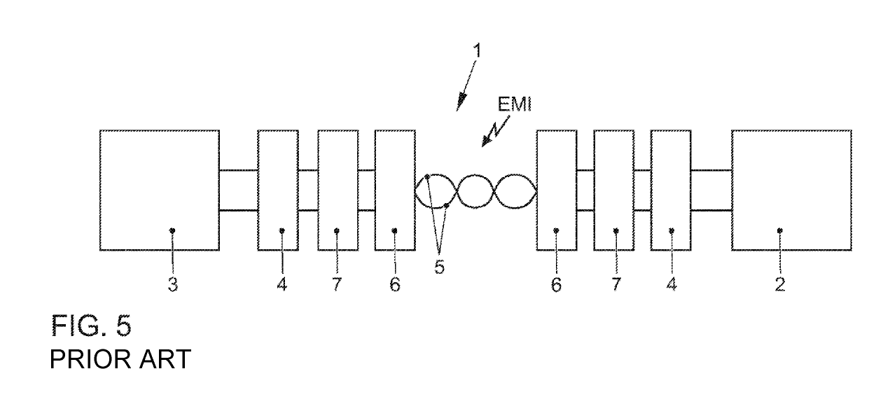

Before the disclosed embodiments are explained in more detail, the prior art should first be briefly explained with reference to FIG. 5. The data transfer system 1 comprises a first control unit 2 and a second control unit 3, through which a bidirectional point-to-point communication can be realized. A discrete first common-mode filter 4 is arranged before each control unit 2, 3, being designed, for example, as a common-mode choke, wherein the two wires of a two-wire cable 5 are wound in opposite directions around a common ferrite core or ring. The two-wire cable 5 is connected at its ends by connectors or plugs 6. Electrical isolation, such as a transformer 7, can be arranged here between the plug 6 and the common-mode filter 4. Alternatively the transformer 7 can also be replaced by a capacitive coupling. The useful signals are transferred between the two control units 2, 3 through differential signals, wherein common-mode components caused by electromagnetic interference, EMI, are filtered out by the common-mode filter 4.

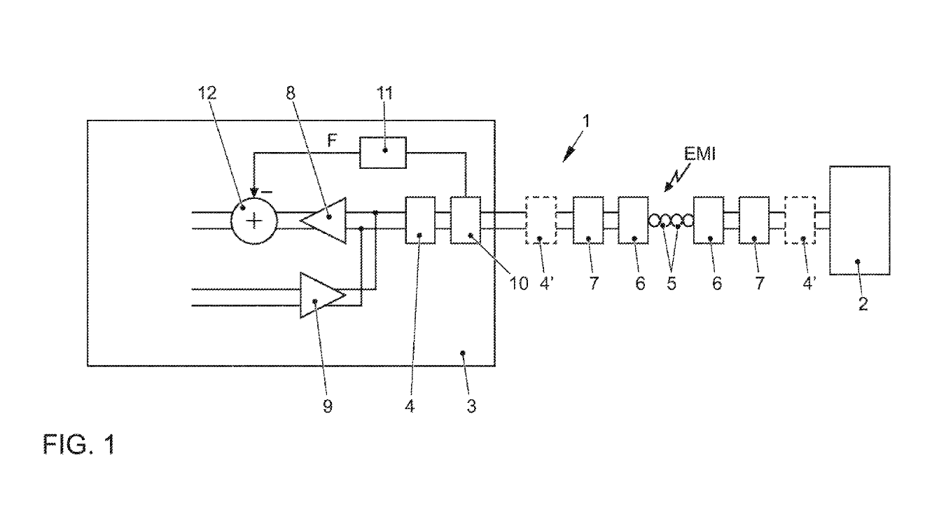

A data transfer system 1 is now illustrated in FIG. 1 in a first disclosed embodiment. The common-mode filter 4 has been integrated here into the control unit 3, more precisely in the chip for a receiver 8 and a transceiver 9 of the control unit 3, wherein the following explanations apply to the second control unit 3 as well as to the first control unit 2. The control unit 3 further comprises a measuring circuit 10 which is arranged in front of the common-mode filter 4 and acquires the common-mode component. The control unit 3 further comprises an error correction circuit 11 which outputs a correction signal F and conveys it to a compensation circuit 12. The correction signal F is then subtracted from the useful signal received from the receiver 8 in the compensation circuit 12, wherein the correction signal F takes differential errors resulting from common-mode signals into account. The receiver 8, transceiver 9, measuring circuit 10, error correction circuit 11 and compensation circuit 12 can here be realized on one chip. A further common-mode filter 4′ can here be arranged in addition in front of the control unit 3, which is illustrated with a dashed line. This common-mode filter 4′ has the function of filtering out the common-mode components as far as possible, in particular, of reducing the common-mode components to a voltage level that can be processed better in the control unit 3. It should further be noted that the transformer 7 is optional. It should further be noted that the error correction circuit 11 is designed in such a way that the transit time of the correction signal F is matched to the useful signal in such a way that they are present synchronously at the compensation circuit 12. The error correction circuit 11 can here also be designed in such a way that preceding signals are taken into account in the determination of the correction signal F, for example, to take charge transfer processes of capacitors into account.

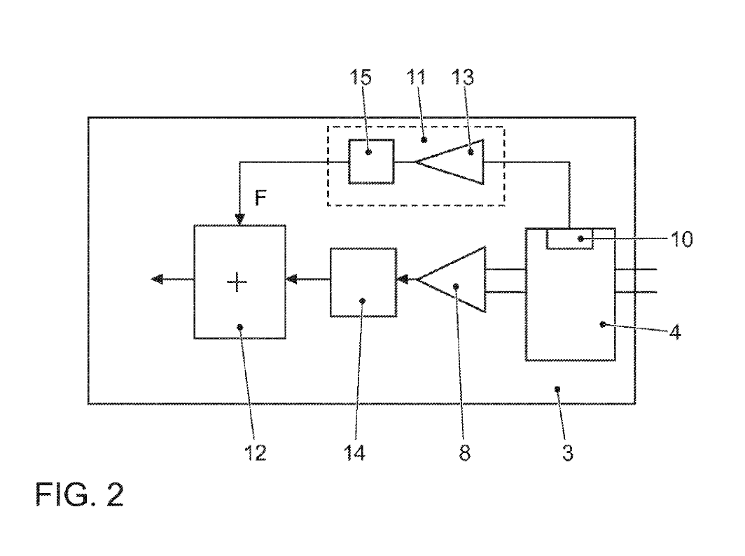

A possible disclosed embodiment of a part of the second control unit 3 is illustrated in more detail by way of example in FIG. 2. In contrast to the illustration according to FIG. 1, the measuring circuit 10 is not located in front of, but rather in the common-mode filter 4. Behind the receiver 8 and an amplifier 13 of the error correction circuit 11, an A/D converter 14, is furthermore arranged in each case, wherein the compensation circuit 12 can then be designed as a digital filter.

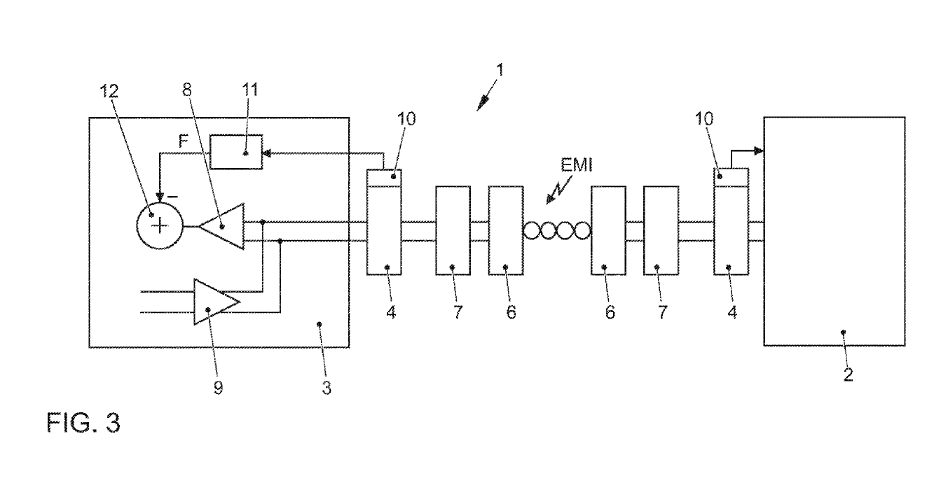

An alternative disclosed embodiment of a data transfer system 1 is illustrated in FIG. 3. In contrast to the disclosed embodiment according to FIG. 1, the common-mode filter 4 is arranged externally, and the measuring circuit 10 is integrated into the common-mode filter 4. The control unit 3 must here accordingly comprise a further input for the measuring device of the measuring circuit 10. In all other respects reference can be made to the explanations for FIG. 1.

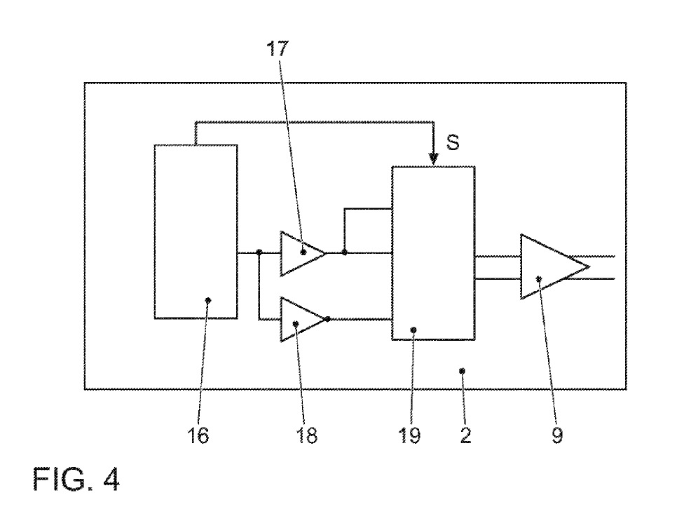

A part of a first control unit 2 is finally illustrated in FIG. 4. The control unit 2 here comprises a microprocessor 16 that generates the useful signals. The useful signal is amplified by a first amplifier 17, and inverted by an inverting amplifier 18, so that the useful signal is present at a multiplexer 19 as a differential signal.

The now amplified useful signal is furthermore connected to a further input of the multiplexer 19. The microprocessor 16 can, by a control signal S, connect either the differential signal or a common-mode signal of the two amplified useful signals through to the transceiver 9. By the common-mode signal, the transfer function of the transfer path can then be determined, in particular, the differential error resulting from a common-mode signal. It should here be noted once again that the explanations for the first control unit 2 also apply to the second control unit 3 and vice versa.

1. A data transfer system, comprising:
a first control unit;
a second control unit; and
a transfer path between the two control units formed at least partially by a two-wire cable through which a useful signal is transferred as a differential signal between the first control unit and the second control unit,
wherein the first control unit comprises a transceiver and the second control unit comprises a receiver,
wherein a measuring circuit is arranged in front of the receiver of the second control unit, the measuring circuit acquires a common-mode component in the useful signal,
wherein an error correction circuit is provided wherein, depending on the acquired common-mode component, a correction signal is generated, wherein a compensation circuit is arranged behind the receiver, and
wherein the compensation circuit is designed so the useful signal received through the receiver is corrected by the correction signal.

2. The data transfer system of claim 1, further comprising a common-mode filter is arranged in front of the receiver.

3. The data transfer system of claim 2, further comprising the common-mode filter is integrated into a chip of the receiver.

4. The data transfer system of claim 2, further comprising the measuring circuit is arranged in front of or in the common-mode filter.

5. The data transfer system of claim 1, further comprising an error correction circuit and/or compensation circuit designed so a differential signal error resulting from a common-mode component in the useful signal to compensate.

6. The data transfer system of claim 5, wherein the differential signal error is specified depending on at least one parameter.

7. The data transfer system of claim 5, wherein the first control unit is designed such that, in a calibration mode, at least one common-mode signal is transferred to the second control unit, wherein a differential signal generated based on the common-mode signal is acquired and used for adjusting the error correction circuit and/or the compensation circuit.

8. A control unit comprising a receiver, wherein at least one of a first and second control units comprises an error correction circuit which is designed that, depending on an acquired common-mode component, a correction signal is generated, wherein a compensation circuit is arranged behind the receiver, wherein the compensation circuit is designed so the useful signal received through the receiver is corrected by the correction signal.

9. The control unit of claim 8, wherein the at least one of the first and second control units further comprises a transceiver, wherein the control unit is designed so that, in a calibration mode, at least one common-mode signal is transferred.

10. A method for data transfer in a data transfer system by a first control unit and a second control unit, the method comprising:
forming a transfer path between the two control units at least partially by a two-wire cable;
transferring a useful signal through the two-wire cable as a differential signal between the first control unit and the second control unit, wherein the first control unit comprises a transceiver and the second control unit comprises a receiver;
acquiring, by a measuring circuit, a common-mode component in the useful signal, wherein the measuring circuit is arranged in front of the receiver of the second control unit;
generating, by an error correction circuit, depending on the acquired common-mode component, a correction signal;
supplying, by the error correction circuit, to a compensation circuit, arranged behind the receiver; and
correcting, by the error correction circuit, the useful signal received from the receiver based on the correction signal.

11. The control unit of claim 8, further comprising a common-mode filter arranged in front of the receiver.

12. The control unit of claim 8, wherein the common-mode filter is integrated into a chip of the receiver.

13. The control unit of claim 12, further comprising a measuring circuit arranged in front of or in the common-mode filter.

14. The control unit of claim 8, further comprising an error correction circuit and/or compensation circuit designed so a differential signal error resulting from a common-mode component in the useful signal to compensate.

15. The control unit of claim 14, wherein the differential signal error is specified depending on at least one parameter.

16. The control unit of claim 14, wherein the first control unit is designed such that, in a calibration mode, at least one common-mode signal is transferred to the second control unit, wherein a differential signal generated based on the common-mode signal is acquired and used for adjusting the error correction circuit and/or the compensation circuit.

17. The method of claim 10, wherein a common-mode filter is arranged in front of the receiver.

18. The method of claim 10, wherein the common-mode filter is integrated into a chip of the receiver.

19. The method of claim 18, wherein a comprising a measuring circuit is arranged in front of or in the common-mode filter.

20. The method of claim 10, wherein an error correction circuit and/or compensation circuit designed so a differential signal error resulting from a common-mode component in the useful signal to compensate.

21. The method of claim 20, wherein the differential signal error is specified depending on at least one parameter.

22. The method of claim 20, wherein the first method is designed such that, in a calibration mode, at least one common-mode signal is transferred to the second method, wherein a differential signal generated based on the common-mode signal is acquired and used for adjusting the error correction circuit and/or the compensation circuit.
